(19) United States
(12) Patent Application Publication
(10) Pub. No.: US 2006/0245005 A1
(43) Pub. Date: Nov. 2, 2006

(54) System for language translation of documents, and methods

(76) Inventors: John M. Hall, Boise, ID (US); Marc Stromberg, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,825

(22) Filed: Apr. 29, 2005

(51) Int. Cl. H04N 1/40

(52) U.S. Cl. 358/448; 358/474

(57) ABSTRACT

Disclosed are multifunction (or “All-in-One”) printing devices that include the capabilities of scanning and printing documents, and which also allow for the creation of machine translations of documents without intervention by the user. The machine translations may rely on local optical character recognition and language translation capabilities within the device itself, or may utilize remote resources. Embodiments of the invention further include methods of machine translation utilizing multifunction devices.

### FIELD OF INVENTION

The present disclosure relates generally to a system for the language translation of printed documents, and more specifically to the language translation of documents by a multifunction printing device.

### BACKGROUND

In many office situations, there is a need to process information and documents in foreign languages, or to communicate with correspondents in a foreign language. Prior to the dramatic growth of information technology, translating documents required the services of an individual knowledgeable in both the “source” and “target” languages. More recently, computerized translation has become available, allowing the production of “machine translations”.

While technological advances have placed many language resources within reach of a typical computer user, obtaining a translation of a printed document typically still involves multiple stages and requires accessing several independent resources. Typically, translating a “paper” document requires first digitally “acquiring” the document; identifying portions of the document containing text; applying optical character recognition (OCR) to the text portions; translating the recognized text; formatting the translated text on a document template; and printing the newly-translated document.

Converting a paper document into a form that may then be digitally processed is typically performed by a digital scanner. Once in a digital form, the document may be transferred to a computer, where the region of interest may be selected and the optical character recognition performed. Once converted to text, a language program may be used to translate the document. OCR and language translation may be performed either locally, such as on a personal computer, or by a remote resource over a network. Both processes are relatively computation-intensive and can significantly benefit, in terms of speed and accuracy, from the power that a large centralized computer can provide. Once translated, a separate resource, such as a word processing program, may be needed to format the new document. The formatted document may then be digitally sent to a printing system to obtain hardcopy output.

Printing systems, including inkjet and laser printers, are well known in the art. In inkjet printing systems, an inkjet printhead is typically mounted on a carriage that is moved back and forth across a print media, such as paper. As the printhead is moved across the print media, a control system activates the printhead to deposit or eject ink droplets onto the print media to form text and images. Ink is provided to the printhead from a supply of ink that is either carried by the carriage or mounted to a fixed receiving station.

In electrophotographic or “laser” printing systems, marking material commonly called “toner” is provided by an electrophotographic engine frequently referred to as a toner cartridge. The toner cartridge often includes an intermediate imaging device such as a drum, and a reservoir of imaging material such as powdered toner. The charge on the drum is modified using an energy source such as a scanning laser. The imaging material is attracted to the charged drum and is then transferred to print media.

Regardless of the printing technology, it has become common for printing systems to incorporate additional functionality, generally by the inclusion of a scanner. These “multifunction” or “All-in-One” systems allow a user to print, scan, copy, and fax documents. The desired function may typically be selected from a control panel on the printing system, or through a software menu structure. Typical control panels may comprise hard-wired buttons or controls, or may comprise liquid crystal displays (LCDs) that may or may not be touch-sensitive (in which case they may be referred to as touchscreens). Such displays normally provide graphical representations of various selectable features, for instance buttons, that the user may select by either touching the display with one's finger or scrolling through the features using an actual control panel button.

There is a need for systems and methods that simplify the process of obtaining machine translations of printed documents in an office setting.

### SUMMARY

Exemplary embodiments of the invention include multifunction (or “All-in-One”) printing devices that include the capabilities of scanning and printing documents, and which also allow for the creation of machine translations of documents without additional intervention by the user. The machine translations may rely on local optical character recognition and language translation capabilities within the device itself, or may utilize remote resources. Embodiments of the invention further include methods of machine translation utilizing multifunction devices.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The invention can be better understood with reference to the following drawings. The components in the drawings are not necessarily to scale.

FIG. 1 depicts an exemplary “Multifunction” printing system in which embodiments of the invention may be utilized;

FIG. 2 is a schematic block diagram illustrating how an exemplary “Multifunction” printing system may typically be connected to external devices and systems;

FIG. 3 illustrates an exemplary document having content in a foreign language;

FIG. 4 illustrates an exemplary document that has been translated and reformatted;

FIG. 5 illustrates an exemplary control panel for an All-in-One printing device incorporating an embodiment of the invention;

FIG. 6 illustrates an exemplary software or firmware menu for an All-in-One printing device incorporating an embodiment of the invention; and

FIG. 7 is a flow diagram illustrating an embodiment of the invention.

### DETAILED DESCRIPTION

Embodiments of the invention are described with respect to an exemplary printing system; however, the invention is not limited to the exemplary system, but may be utilized in other systems.

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

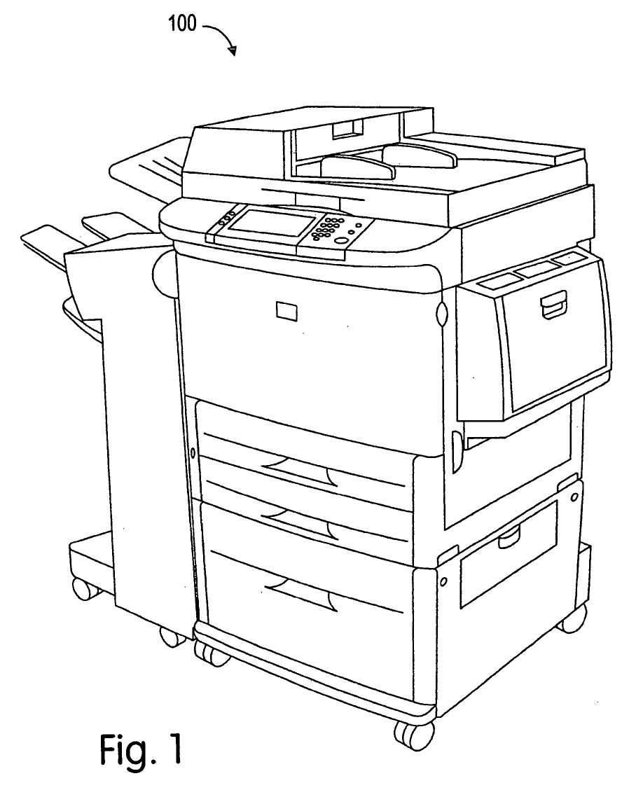

FIG. 1 illustrates an exemplary printing system 100 in which embodiments of the invention may be utilized. Intended for moderately high volume printing, the illustrated system includes multiple other functions and may, for example, be connected to an office network to provide printing, scanning, copying, and faxing capabilities to a workgroup. The exemplary printing system 100 may comprise an electrophotographic or “laser” printer, or may employ another printing technology, such as inkjet. Embodiments of the invention may of course also be utilized in other “All-in-One” systems, such as smaller multifunction systems intended for personal use.

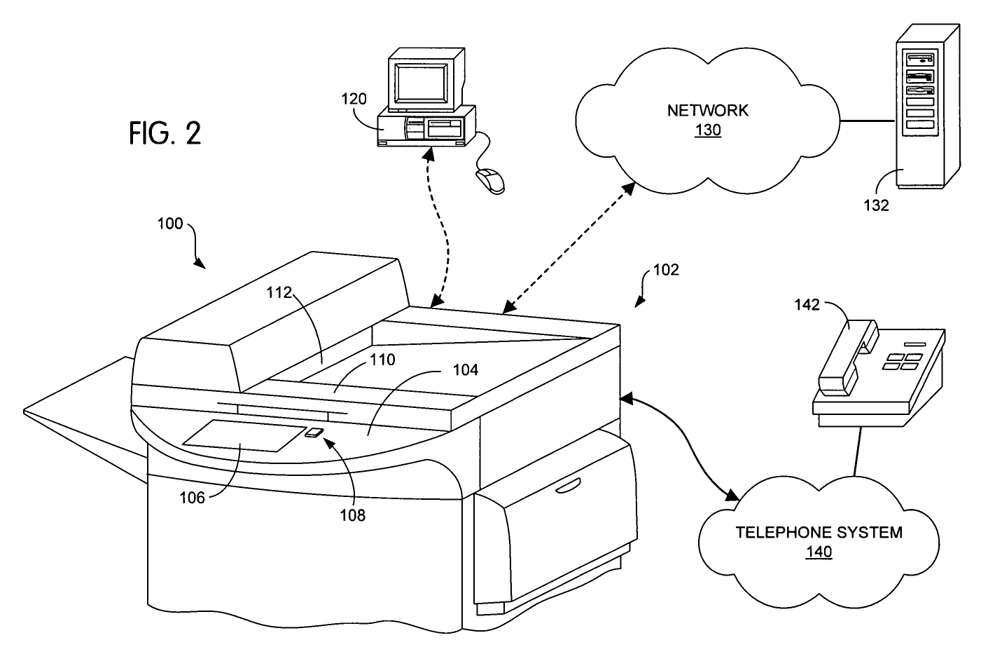

FIG. 2 is a schematic block diagram illustrating how an exemplary “All-in-One” printing system 100 may typically be connected to external devices and systems. Irrespective of its particular nature, the exemplary printing system 100 includes a control panel 104 that comprises a display 106 with which various screens containing selectable features can be presented to the user. By way of example, the display 106 may comprise a liquid crystal display (LCD) that is touch-sensitive. In addition to the display 106, the control panel 104 may, optionally, include physical controls such as buttons 108. The exemplary “All-in-One” system typically includes a controller (not visible) which includes firmware or software which controls the functions of the device, including scanning, printing, and communicating with external devices.

The exemplary printing system 100 may be connected, either directly or wirelessly, to a local computing device 120, which may comprise a personal computer (PC) or a remote computing device 132, which may comprise a server, via a network 130. As is discussed below, either computing device 120, 132 may serve as a source for selecting language translation options. In addition, the local computing device 120 may further provide a means for displaying options to the user. Where used, the network 130 typically comprises one or more sub-networks that are communicatively coupled to each other. By way of example, these networks can include one or more local area networks (LANs) and/or wide area networks (WANs). In some embodiments, the network 130 may comprise a set of networks that forms part of the Internet.

The exemplary All-in-One printing system 100 also provides faxing capabilities, and may be connected to a telephone system 140 to which other fax machines or telephones 142 may also be connected. For scanning, copying, and faxing, the exemplary printing system 100 includes a flatbed scanner which may be accessed by raising a cover 110, or by feeding a document through a paper feeder 112.

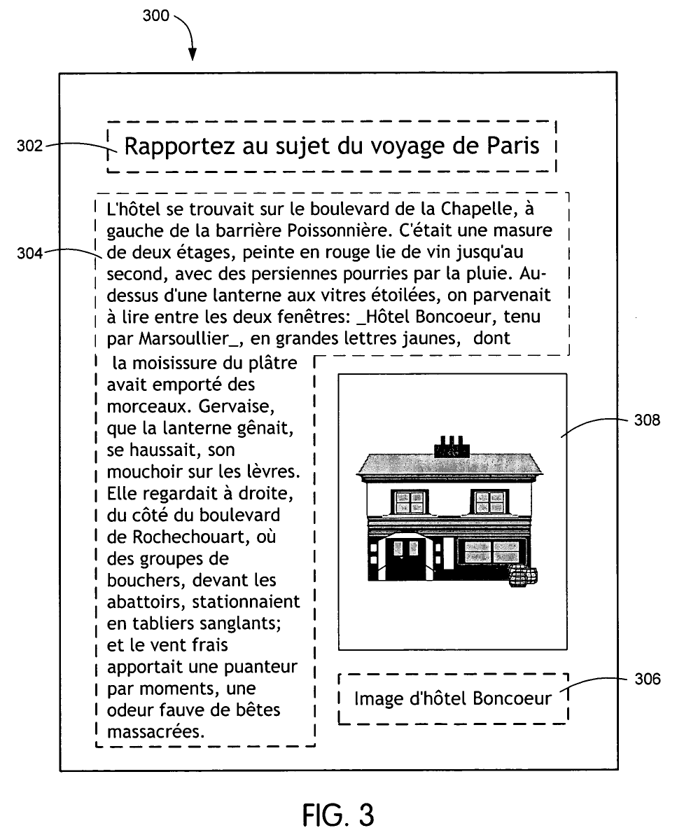

FIG. 3 illustrates an exemplary 300 document having content in a foreign language. The document may, for example, include several areas 302, 302, 304 consisting of text, and other areas 306 consisting of images or graphics. The text, for example, may include narrative sections 304 of some length, as well as titles 302 and captions 306.

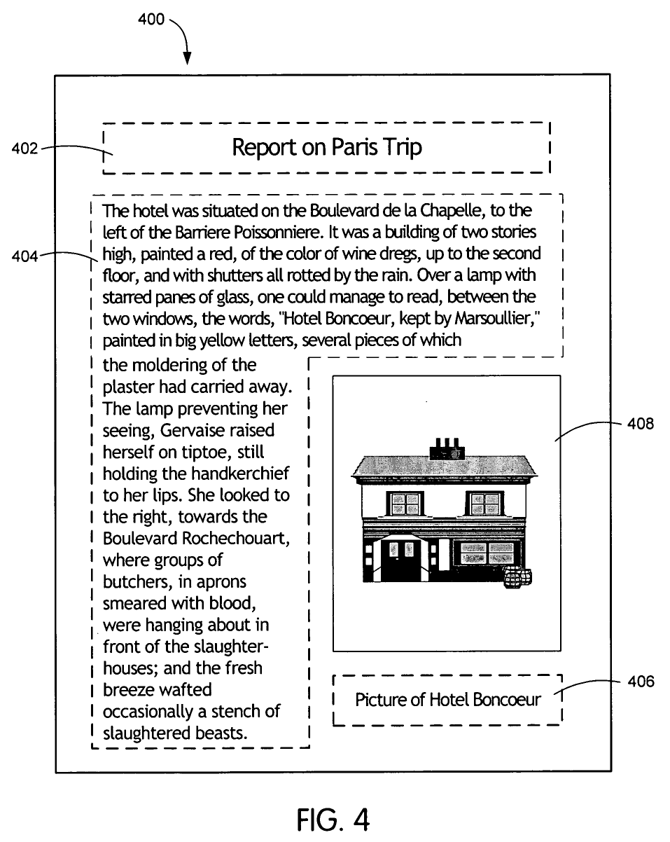

FIG. 4 illustrates an exemplary document 400 that has been translated and reformatted. Ideally, the overall arrangements of elements are preserved, and the narrative sections 404, titles 402, and captions 406 are preserved in their approximate relationship to graphics or images 408.

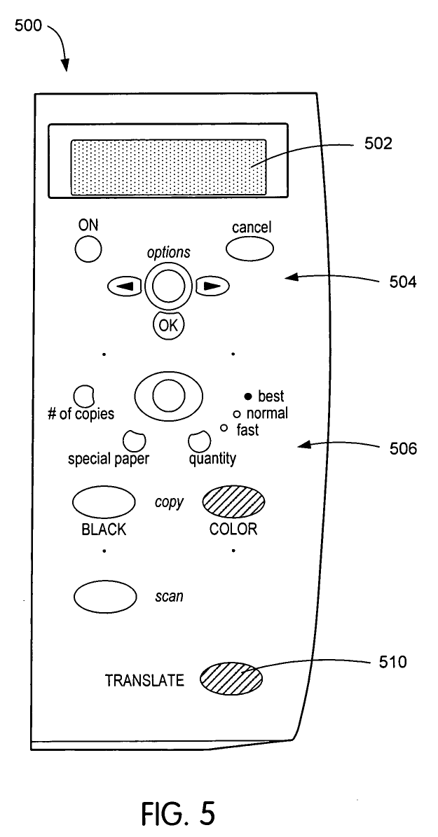

FIG. 5 illustrates an exemplary control panel 500 for an All-in-One printing device incorporating an embodiment of the invention. The exemplary panel 500 may include a display 502 for displaying menu options, and an array of buttons 504 for navigating through the menus. The panel may further include dedicated buttons 506 for selecting copy and print options.

In an embodiment of the invention, a multifunction machine includes a button 510 (either a physical “hardwired” button or a “virtual” button on a touchscreen) which initiates language translation. Alternative, multiple buttons may be used (not shown), such as separate buttons to initiate translations to different languages. If the user places a document to be translated on the scanning portion of the multifunction device (either upon a scanning surface or in a sheet feeder) and presses the “translation” button, embodiments of the invention include scanning the input document; identifying text portions of the document; converting the imaged text to alphanumeric text; translating the alphanumeric text; reformatting the document; and printing the result. Embodiments of the present invention thus provide a simple process for obtaining machine translations that does not require the operator to independently access multiple resources.

Optical character recognition (OCR) and language translation may use the local resources of the “All-in-One”, or may access remote resources over a network connection. For example, the language translation may be performed by a translation package running on a centralized computer within an organization, or may be a service provided over the Internet.

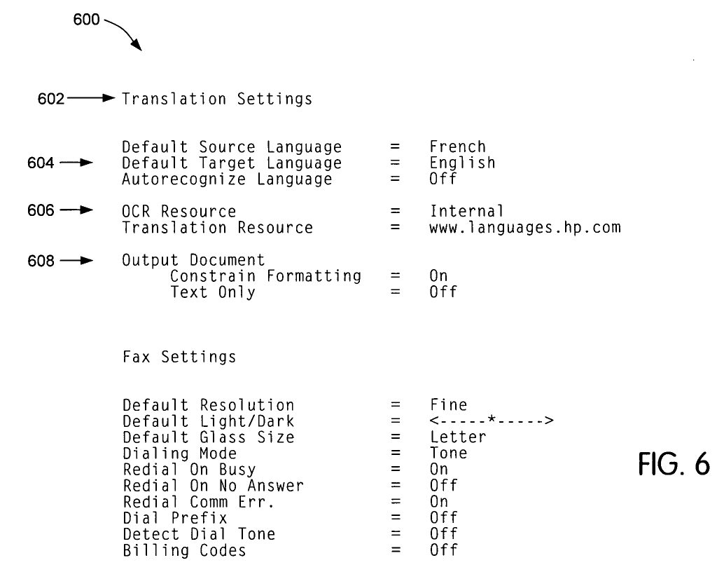

In addition to or as an alternative to embodiments utilizing a physical “translate” button 510, a “translate” mode may be selected in firmware, or translation parameters may be set such that the best performance may be obtained. As shown in FIG. 6, a menu structure 600 may be a subset of a larger menu that includes options for other functions, such as faxing. The “Translation Settings” may include the ability to specify “source” and “target” languages 604, for example, to improve the translation quality and reduce translation time; or the ability to specify that the system attempt to “autorecognize” the source language. Embodiments of the invention may also allow the OCR and Translation resources to be specified, such as by identifying an external source, such as an IP address or website, to perform the translation. The menus may include options pertaining to the formatting of the output document 608, such as, for example, whether the identified regions of text and images of the original document be preserved in the translated document, or whether a “text only” output is desired. The menu may be presented as part of a “virtual” menu on a front panel display of the multifunction device, such as display 106 of FIG. 2, or may form part of a driver routine residing on an external personal computer 120 or networked computer 132.

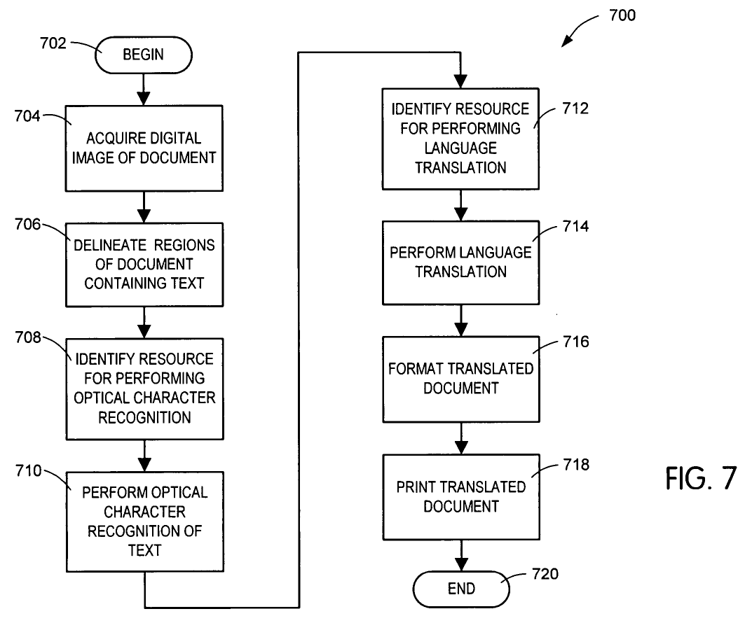

FIG. 7 is a flow diagram further summarizing a method 700 of the invention. Embodiments of the invention include performing the method 700 upon receipt of a single request by the user, such as the pressing of a “translate” button or selection of “translate” from a menu structure, without additional intervention by the user. The method begins 702 by acquiring 704 a digital image of a document. Typically, this accomplished utilizing the scanner integral with the multifunction device; however, other methods may be used, such as receiving a previously created digital image (such as a scan or a photograph) from an external source, such as from a computer, over a network, or as a facsimile transmission. The document may be a single page or multiple pages, The method then delineates 706 those portions of the image that contain text, utilizing techniques known in the art. Once the areas containing text are identified, the method determines a resource 708 for optical character recognition. In some embodiments, the resource may be internal; in others, an external resource may be identified, such as a remote computer on a network, or a website on the internet. Optical character recognition is then performed 710 on the areas of text, utilizing techniques known in the art. The OCR may use knowledge of the source language of the document, such as that obtained from a menu setting of the device, to improve OCR results.

Once text versions of the areas of interest in the document are obtained from the OCR resource, the exemplary method then determines 712 a language translation resource. In some embodiments, the resource may be internal; in others, an external resource may be identified, such as a remote computer on a network, or a website on the internet. The identified resource than translates 714 the text. If the text is translated by an external resource, the translated text may be returned to the multifunction device over the appropriate network or internet connection. A translated document is then formatted 716; in some embodiments, the formatted document may substantially duplicate the formatting of the original, untranslated document; in other embodiments, a different format may be used, such as a “text only” format. If the translated document is intended substantially match the original document in format, then, if the translated text does not fit in the appropriate areas, the font, spacing, or margins of the document may be adjusted. Once the translated document is formatted, it is printed 718 on the integral printing system of the multifunction device, and the method ends 720.

Thus, embodiments of the device provide methods of translating printed documents which greatly reduce the actions necessary by the user. The user, for example, may only need to place the document on the multifunction device, press “translate”, and receive the final printed output. Thus, a translation may be produced with no greater effort than that required to produce a photocopy.

Any process steps or blocks in the flow diagram of FIG. 7 may represent modules, segments, or portions of code that include one or more executable instructions for implementing specific logical functions or steps in the process. Although particular example steps are described, alternative implementations are feasible. Moreover, steps may be executed out of order from that shown or discussed, including substantially concurrently or in reverse order, depending on the functionality involved.

In some embodiments, various steps may all be performed by the same external resource, such as, for example, the optical character recognition, translation, and formatting of the translated document. Further, these steps may not require separate intervention, requests, or commands by the multifunction device, but may be initiated by a single transmission or transaction.

Various programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The disclosed programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. In a multifunction printing system having a document scanner, a method of translating documents, comprising: upon initiation by a user, and without additional intervention by the user
acquiring a digital image of a document;
delineating regions of the document containing text;
performing optical character recognition of the delineated regions to produce text; and
performing language translation of the text.

2. The method of claim 1, further comprising, without additional intervention by the user, formatting the language translated text into a document and printing the document.

3. The method of claim 1, wherein the step of performing optical character recognition of the delineated regions further comprises first identifying a resource for performing optical character recognition.

4. The method of claim 3, wherein identifying a resource for performing optical character recognition identifies an internal resource of the multifunction device.

5. The method of claim 3, wherein identifying a resource for performing optical character recognition identifies an external resource.

6. The method of claim 5, wherein the external resource is an internet website.

7. The method of claim 1, wherein the step of performing language translation of the text further comprises first identifying a resource for language translation.

8. The method of claim 7, wherein identifying a resource for performing language translation identifies an internal resource of the multifunction device.

9. The method of claim 7, wherein identifying a resource for performing language translation identifies an external resource.

10. The method of claim 9, wherein the external resource is an internet website.

11. The method of 1, wherein the step of performing optical character recognition of the delineated regions further comprises utilizing a menu setting stored within the multifunction device to specify a source language of the document to improve optical character recognition accuracy.

12. The method of claim 1, wherein the step of performing language translation of the text further comprises utilizing a menu setting stored within the multifunction device to specify the source language of the document.

13. The method of claim 1, wherein the step of performing language translation of the text further comprises automatic recognition of the source language of the document.

14. The method of claim 1, wherein the step of performing language translation of the text further comprises utilizing a menu setting stored within the multifunction device to specify the target language of the translation.

15. The method of claim 1, wherein initiation by the user comprises pressing a button on the multifunction device.

16. The method of claim 1, wherein initiation by the user comprises selecting an option from a menu.

17. A multifunction printing system, comprising:
a printing device;
a document scanner;
a controller, the controller performing the functions, upon initiation by a user, and without additional intervention by the user, of
acquiring a digital image of a document;
delineating regions of the document containing text;
performing optical character recognition of the delineated regions to produce text; and
performing language translation of the text.

18. The multifunction printing system of claim 17, further comprising, without additional intervention by the user, formatting the language translated text into a document and printing the document.

19. The multifunction printing system of claim 17, wherein the step of performing optical character recognition of the delineated regions further comprises first identifying a resource for performing optical character recognition.

20. The multifunction printing system of claim 19, wherein identifying a resource for performing optical character recognition identifies an internal resource of the multifunction device.

21. The multifunction printing system of claim 19, wherein identifying a resource for performing optical character recognition identifies an external resource.

22. The multifunction printing system of claim 21, wherein the external resource is an internet website.

23. The multifunction printing system of claim 17, wherein the step of performing language translation of the text further comprises first identifying a resource for language translation.

24. The multifunction printing system of claim 23, wherein identifying a resource for performing language translation identifies an internal resource of the multifunction device.

25. The multifunction printing system of claim 23, wherein identifying a resource for performing language translation identifies an external resource.

26. The multifunction printing system of claim 25, wherein the external resource is an internet website.

27. The multifunction printing system of 17, wherein the step of performing optical character recognition of the delineated regions further comprises utilizing a menu setting stored within the multifunction device to specify a source language of the document to improve optical character recognition accuracy.

28. The multifunction printing system of claim 17, wherein the step of performing language translation of the text further comprises utilizing a menu setting stored within the multifunction device to specify the source language of the document.

29. The multifunction printing system of claim 17, wherein the step of performing language translation of the text further comprises automatic recognition of the source language of the document.

30. The multifunction printing system of claim 17, wherein the step of performing language translation of the text further comprises utilizing a menu setting stored within the multifunction device to specify the target language of the translation.

31. The multifunction printing system of claim 17, wherein initiation by the user comprises pressing a button on the multifunction device.

32. The multifunction printing system of claim 17, wherein initiation by the user comprises selecting an option from a menu.
